(19) United States
(12) Patent Application Publication
(10) Pub. No.: US 2017/0089792 A1
(43) Pub. Date: Mar. 30, 2017

(54) DAMPENED PRESSURE PORT

(71) Applicant: Merit Medical Systems, Inc., South Jordan, UT (US)

(72) Inventors: Rick Russell, South Jordan, UT (US); Jonathan Cheney, South Jordan, UT (US); Scott Sidwell, South Jordan, UT (US); Luca Salmaso, South Jordan, UT (US); Jeff Chance, South Jordan, UT (US); Greg Liddiard, South Jordan, UT (US)

(21) Appl. No.: 15/277,715

(22) Filed: Sep. 27, 2016

Related U.S. Application Data
(60) Provisional application No. 62/233,850, filed on Sep. 28, 2015.

(51) Int. Cl. G01L 19/06; G01L 19/14

(52) U.S. Cl. CPC G01L 19/06; G01L 19/147

(57) ABSTRACT

Sensor assemblies and related components and methods are disclosed. In some instances, the sensor assemblies include a sensor mounting body and a porous member. The porous member can be disposed within an aperture that extends through a sensor mounting body. The porous member may function as a dampening element or snubber that impedes the propagation of one or more pressure waves across the aperture. Some assemblies may include a metallized layer.

### RELATED CASES

This application claims priority to U.S. Provisional Application No. 62/233,850, filed on Sep. 28, 2015 and titled “DAMPENED PRESSURE PORT,” which is hereby incorporated by reference in its entirety.

### TECHNICAL FIELD

The present disclosure relates generally to the field of pressure sensing assemblies and components. More particularly, some embodiments of the disclosure are directed to sensor assemblies that include a porous member for protecting a pressure sensor.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a pictorial view of a pressure port assembly.

FIG. 2 is an exploded view of the pressure port assembly of FIG. 1.

FIG. 3 is a pictorial view of a pressure port body of the pressure port assembly of FIG. 1.

FIG. 4 is a side cross-sectional view of the pressure port body of FIG. 3.

FIG. 5 is a cross-sectional exploded view of a sensor assembly.

FIG. 6 is a cross-sectional side view of the sensor mounting body of the sensor assembly of FIG. 5.

FIG. 7 is an exploded perspective view of a pressure port assembly according to another embodiment.

FIG. 8 is a cross-sectional side view of the pressure port assembly of FIG. 7.

FIG. 9 is an exploded perspective view of a pressure port assembly according to another embodiment.

FIG. 10A is an exploded perspective view of a pressure port assembly according to another embodiment.

FIG. 10B is a non-exploded perspective view of the pressure port assembly of FIG. 10A.

FIG. 10C is a cross-sectional view of the pressure port assembly of FIGS. 10A and 10B through plane 10C-10C.

FIG. 10D is a cross-sectional view of the pressure port assembly of FIGS. 10A-10C through plane 10D-10D.

### DETAILED DESCRIPTION

This disclosure broadly relates to pressure ports, pressure port assemblies, sensor assemblies, and related methods. As used herein, a “pressure port” refers to any mounting body or component configured to accommodate a pressure sensing element, such as a pressure transducer. Exemplary pressure ports include any body, housing, mount, or similar elements, such as ferrules, grommets, and so forth. Pressure ports may be used to secure a pressure transducer within a larger assembly. Additionally, pressure ports may be configured to protect portions of a pressure transducer from corrosive or harsh environments. Portions of a pressure port may form a fluidic seal against other elements of an assembly.

The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

The phrase “coupled to” is broad enough to refer to any suitable coupling or other form of interaction between two or more entities, including mechanical, fluid, and thermal interaction. Two components may be coupled to each other even though they are not in direct contact with each other. For example, two components may coupled to one another through an intermediate component. The phrases “attached to” and “attached directly to” refer to interaction between two or more entities which are in direct contact with each other and/or are separated from each other only by a fastener (e.g., adhesives, screws) of any suitable variety. The phrase “fluid communication” refers to arrangements in which a fluid (e.g., a gas or a liquid) can flow from one element to another element when the elements are in fluid communication with each other.

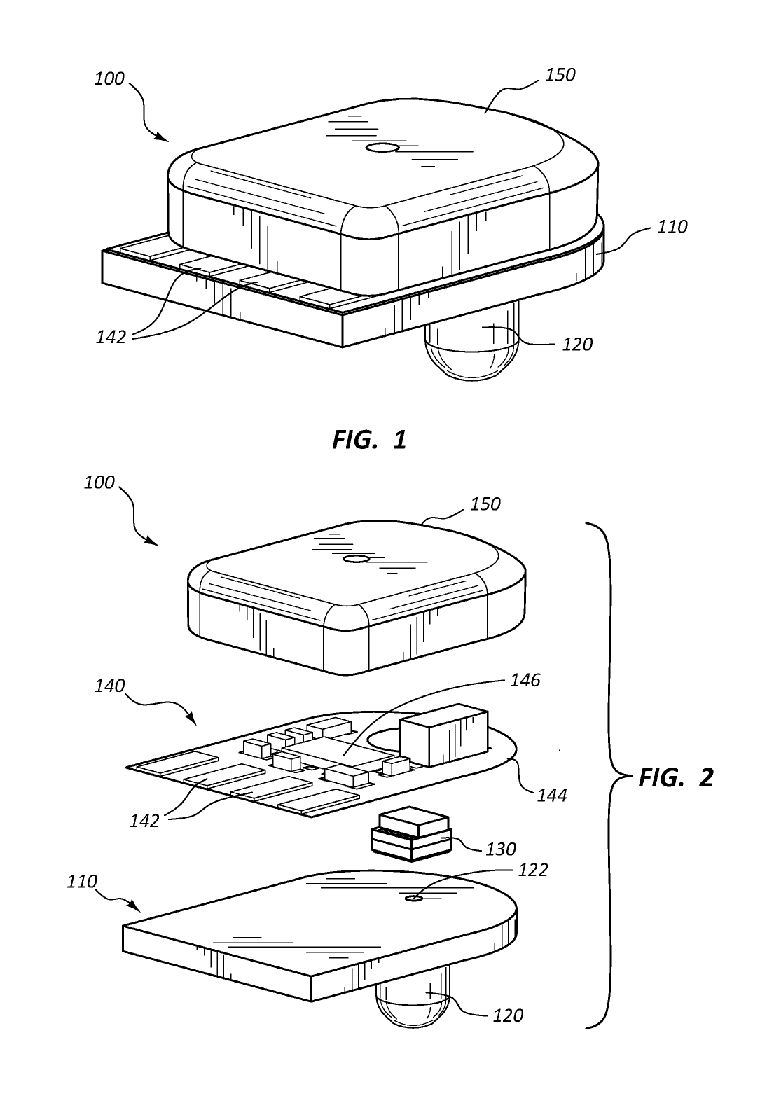

FIG. 1 is a pictorial view of a pressure port assembly 100, which also may be referred to as a “sensor assembly.” FIG. 2 is an exploded view of the pressure port assembly 100 of FIG. 1. As shown in FIGS. 1 and 2, the pressure port assembly 100 may comprise a pressure port body 110, which may also be referred to as a sensor mounting body. A pressure sensing element, such as the pressure transducer 130 may be coupled to the pressure port body 110. Still further, an electronics assembly 140 may be coupled to the pressure port body 110 and may be in electrical communication with the pressure transducer 130. Finally, a cover 150 may be coupled to the pressure port body 110. In some instances the cover 150 may be disposed such that it is disposed over all or a portion of the pressure transducer 130 and/or the electronics assembly 140. The cover 150 may be made from any suitable material, such as ceramic or plastic.

The pressure port assembly 100 may be understood or characterized in a number of ways. For example, the pressure port assembly 100 may be characterized as an assembly of components configured to be used in connection with a larger assembly. The pressure port body 110 may thus provide a mounting surface or attachment point for elements of the pressure port assembly 100 and function as an attachment member to couple the pressure port assembly 100 to the larger assembly. Further, the pressure port assembly 100 may be understood as controlling fluid communication to various portions of the pressure port assembly 100. For example, the pressure port assembly 100 may be designed such that portions of the pressure port assembly 100, for example the electronics assembly 140, are isolated from communication with a fluid to be measured, while allowing communication with a portion of the pressure transducer 130. The pressure port assembly 100 may thus be configured to interact with the larger assembly to provide surfaces for fluidic seals as well as mounting or attachment surfaces. These characterizations of the pressure port assembly 100 are further described and outlined below.

The pressure port body 110 may be configured as an interface between components mounted on the pressure port body 110 and a larger assembly. As noted above, elements such as a pressure sensing element, such as pressure transducer 130, and various electronic components, such as the electronics assembly 140, may be coupled directly to the pressure port body 110. The pressure port body 110 may, in turn, be an element of a larger assembly, positioning the pressure transducer 130 and electronics assembly 140 within the larger assembly to measure pressure and/or provide an output signal.

Accordingly, in some embodiments, the pressure port assembly 100 may be understood as an integrated component, a package comprising pressure sensing elements that can be disposed within, and as part of, a larger assembly. For example, the pressure port assembly 100 may be sized and designed to be disposed in communication with the fluid flow path, with the pressure port body 110 providing an attachment interface to a housing or other element defining the fluid flow path, and the pressure transducer 130 in fluid communication with the fluid flow path. The pressure port assembly 100 may be configured as an element of any number of larger assemblies. For example, the pressure port assembly 100 may be sized or configured to be placed within a portion of a syringe housing, with the pressure port body 110 coupled to the housing and the pressure transducer 130 in fluid communication with an interior portion of the syringe. Another example may be a fuel line, with the pressure port body 110 configured to be placed within a housing and coupled to an element of the fuel line, and the pressure transducer 130 in fluid communication with fluid within the fuel line.

The pressure port assembly 100 may thus be understood both as an integrated platform for elements of the assembly (such as the pressure transducer 130 and the electronics assembly 140) and as an interface platform with a larger assembly. As such, the relative positions, physical or material properties, or other characteristics of the elements of the pressure port assembly 100 may be designed or tailored to meet design characteristics driven both by designing an integrated pressure port assembly 100 and by configuring that assembly for interaction with a larger assembly.

For example, in addition to providing a mounting surface to interface with the larger assembly, the pressure port body 110 may separate or isolate portions of the pressure port assembly 100 from portions of the larger assembly. For example, the pressure port body 110 may comprise a material which resists corrosion or breakdown in the presence of harsh or corrosive environmental conditions. The pressure port body 110 may separate or isolate other portions of the pressure port assembly 100 from such conditions, while providing fluid communication only to targeted portions of the pressure port assembly 100.

The pressure port body 110 shown in FIGS. 1 and 2 comprises an aperture top opening 122 in the pressure port body 110. The aperture top opening 122 may be in communication with an aperture (125 of FIG. 4) and may thus provide fluid communication from one side of the pressure port body 110 to the other, thus providing fluid communication along a defined and controlled path. Other portions of the pressure port body 110 may be fluid-impermeable and/or sealed against fluid communication around the pressure port body 110 in order to control fluid communication with respect to other elements of the pressure port assembly 100, such as the pressure transducer 130 and/or the electronics assembly 140.

In some instances, it may be desirable to isolate the electronics assembly 140 and portions of the pressure transducer 130 from fluid communication with the fluid to be measured. Uncontrolled fluid communication with these elements may compromise the integrity of these components by corroding or otherwise damaging the components. Further, uncontrolled fluid communication around the pressure transducer 130 may compromise the pressure reading of the pressure transducer 130. In the illustrated embodiment, the pressure transducer 130 and the electronics assembly 140 are mounted on a first surface (or transducer surface 112) of the pressure port body 110.

For convenience in describing the components herein, the transducer surface 112 may be understood as a top surface of the pressure port body 110, as FIGS. 1 and 2 are oriented with the transducer surface 112 directed toward the top of the figures. Thus, the opening in the transducer surface 112 at the top of the aperture 125 (see FIG. 4) is referenced as a top opening 122. As detailed below, the opposing opening is referenced as a bottom opening (124 of FIG. 4). Other components herein may be referred to using this same relative coordinate system. References to “top” and “bottom” are for convenience only and do not imply an absolute coordinate system or any particular orientation of the pressure port assembly 100 within a larger assembly or with reference to an external or environmental coordinate system.

The transducer surface 112 may be isolated from fluid communication with the fluid to be measured. For example, sealing members may prevent fluid flow around the periphery of the pressure port body 110, and the material of the pressure port body 110 may prevent fluid communication through the pressure port body 110. As further detailed below, the aperture (125 of FIG. 4) may be relatively disposed such that fluid communication at the transducer surface 112 is isolated to the aperture top opening 122.

In some embodiments, the pressure transducer 130 may be disposed directly over the top opening 122 such that the aperture (125 of FIG. 4) is in communication with a bottom surface of the pressure transducer 130. A bond between the pressure transducer 130 and the transducer surface 112 of the pressure port body 110 may seal the interface between the pressure transducer 130 and the transducer surface 112, thus allowing for fluid communication between one surface of the pressure transducer 130 and the aperture (125 of FIG. 4) without fluid communication between the aperture (125 of FIG. 4) and the transducer surface 112 generally.

The pressure transducer 130 may be attached to the transducer surface 112 through bonding, welding, adhesives, chemical bonding, mechanical bonding, soldering and so forth. In some instances, eutectic solder is used to bond the pressure transducer 130 to the transducer surface 112 of the pressure port body 110. In another example, glass bonding, such as glass soldering or frit bonding, is used to couple the pressure transducer 130 to the transducer surface 112 of the pressure port body 110.

The pressure transducer 130 may comprise any type of pressure sensing element or component. In some embodiments, a MEMS transducer may be used. The portion of the pressure transducer 130 configured for interaction with the fluid to be measured may be positioned in fluid communication with the aperture (125 of FIG. 4) while the remaining surfaces of the pressure transducer 130 may be isolated from fluid communication with the aperture (125 of FIG. 4) due to one or more of: the impermeability of the pressure port body 110, seals preventing fluid communication around the periphery of the pressure port body 110, and the nature of the bond or seal between the pressure transducer 130 and the transducer surface 112.

Positioning of the pressure transducer 130 and the electronics assembly 140 on the transducer surface 112, in embodiments where this area is not in fluid communication with the fluid to be measured, may facilitate coupling between the pressure transducer 130 and the electronics assembly 140 and protect these components. For example, the fluid to be measured may be corrosive or otherwise incompatible for contact with these elements. Still further, electrical pathways between portions of the electronics assembly 140 may be disrupted or compromised by the presence of a certain fluids. Mounting the pressure transducer 130 on the top side of the pressure port body 110, while the fluid to be measured is disposed on the bottom side thereof, may thus facilitate use of certain types of components and arrangements within the pressure port assembly 100.

The electronics assembly 140 may be attached directly to the pressure port body 110. In some embodiments, the pressure port body 110 may comprise a ceramic or other substrate suitable for direct metallization to create electrical pathways. Electrical pathways or other portions of the electronics assembly 140 may be created by deposition, etching, doping, printing, or other methods, including instances where these processes are done directly on the pressure port body 110.

In other embodiments, the electronics assembly 140 may be initially printed or otherwise formed on a secondary member, such as chip carrier 144. The chip carrier 144 may comprise a plastic or other substrate upon which components of the electronics assembly 140 are initially deposited, printed, or otherwise coupled thereto. The chip carrier 144 may then be coupled to the pressure port body 110. In some embodiments, duplication technology, such as reel-to-reel printing or other methods, may be used to produce the chip carrier 144 with the electronics assembly 140 components thereon.

The electronics components may further comprise a plurality of contacts 142. The contacts 142 may be directly printed on, directly deposited on, or otherwise attached directly to the pressure port body 110. In other instances the contacts 142 may be initially disposed on a chip carrier (such as chip carrier 144) which is coupled to the pressure port body 110. The contacts 142 may be in electrical communication with pathways of the electronics assembly 140, including pathways in ultimate connection with the pressure transducer 130. The contacts 142 may thus provide a single input or output coupling location.

In some embodiments, the electronics components further include an integrated circuit 146. The integrated circuit 146 may perform one or more operations on a signal from the pressure transducer 130 and then send or relay the signal to the electrical contacts 142.

In some embodiments, the transducer 130 and various electronics components, such as the integrated circuit 146, are discrete and separate components. In other embodiments, the transducer 130 and the integrated circuit 146 (and/or one or more electronic components) are incorporated into a single component. For example, in some embodiments the transducer 130 and the integrated circuit 146 may both be incorporated into a single chip and/or may both be disposed in a common housing.

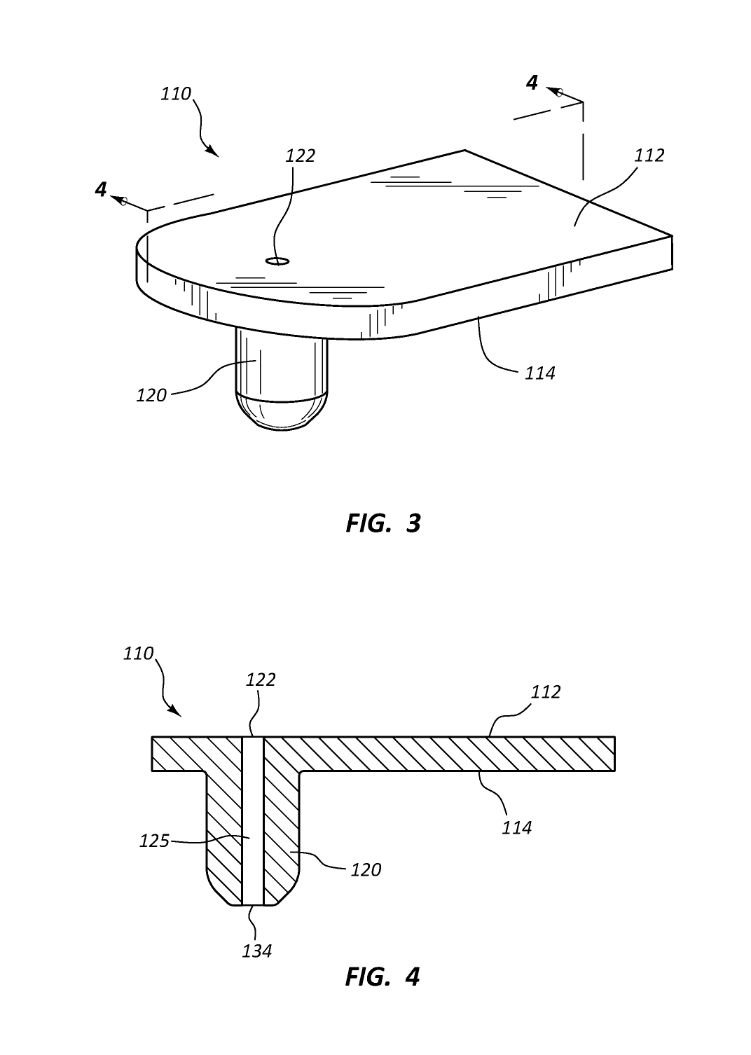

FIG. 3 is a pictorial view of a pressure port body 110 of the pressure port assembly (100 of FIG. 1). FIG. 4 is a side cross-sectional view of the pressure port body 110 of FIG. 3.

As shown in FIGS. 1-4, the pressure port body 110 may comprise a first surface, such as a top surface, or the transducer surface 112 of the illustrated embodiment. The transducer surface 112 may be substantially flat or otherwise configured such that portions thereof may be directly metallized as part of the electronics assembly 140. The transducer surface 112 may be relatively positioned as a mounting surface for the pressure transducer 130 and/or electronics assembly 140 in some embodiments. Further, seals or other components may isolate the transducer surface 112 from fluid communication with a fluid to be measured.

The pressure port body 110 may further comprise a second surface such as bottom surface 114, disposed opposite the transducer surface 112. In some instances, portions of the bottom surface 114 may be in fluid communication with the fluid to be measured. Seals or other components may prevent fluid communication around the periphery of the bottom surface 114 in some instances.

In the illustrated embodiment, the pressure port body 110 further comprises a protrusion 120 extending from the bottom surface 114. The protrusion 120 may be an integral component or portion of the pressure port body 110. In the illustrated embodiment, the protrusion 120 is shown with a circular cross-section, though any other shape is within the scope of this disclosure. In the depicted embodiment, the protrusion 120 is offset to one side. In other embodiments, the protrusion may be centered such that the protrusion extends from a middle of the pressure port body 110. Centering of the protrusion may, in some instances, allow for a decreased overall size of the pressure port assembly 100.

An aperture 125 may extend from a bottom opening 124 to a top opening 122, providing a defined path for fluid communication across the pressure port body 110. Again, the bonding of the pressure transducer 130 to the transducer surface 112 may seal the top opening 122 of the aperture 125, allowing for fluid communication between the aperture 125 and the bottom of the pressure transducer 130, but preventing fluid communication between the aperture 125 and other components disposed on the transducer surface 112.

In the illustrated embodiment, the bottom opening 124 of the aperture 125 is positioned on the protrusion 120. In other embodiments, the bottom opening 124 may be disposed in the bottom surface 114 of the pressure port body 110, including embodiments with no protrusion 120.

When the pressure port assembly 100 is disposed within a larger assembly, the protrusion 120 may extend toward a fluid to be measured. For example, the protrusion 120 may extend such that is it adjacent to a fluid flow path. The aperture 125 would thus provide fluid communication from that fluid flow path to the pressure transducer 130, facilitating pressure measurements of the fluid in the flow path.

Sealing members of various kinds may be utilized to prevent fluid flow around the periphery of the pressure port body 110. In some instances, a seal may be positioned around the perimeter of the pressure port body 110, while in other embodiments a seal may be disposed against the bottom surface 114 of the pressure port body 110. Still further, in some embodiments, one or more seals may be disposed around the protrusion 120 to prevent fluid communication around the periphery of the protrusion 120. For example, O-rings or similar members may be disposed around the protrusion 120. In embodiments where the bottom opening 124 of the aperture 125 is in communication with a fluid to be measured, such O-rings or other seals may prevent fluid leaking around the pressure port body 110.

The pressure port body 110 may comprise a single material, including embodiments wherein the pressure port body 110 is integrally formed from a single material. Stated another way, the pressure port body 110 may comprise a continuous or unbroken member. In some instances, the pressure port body 110 may comprise a ceramic material. The ceramic material may be injection-molded such that the entire pressure port body 110, including, for example, the protrusion 120, comprises a continuous and unbroken ceramic element.

The continuous material of the pressure port body 110 may be impermeable to fluid flow across the material. In some embodiments, the pressure port body 110 may be configured for use in communication with harsh or corrosive fluids including both liquids and gasses. The impermeability of the pressure port body 110 may facilitate isolation of such fluids from other portions (such as the electronics assembly 140) of the pressure port assembly 100.

A continuous pressure port body 110 may limit potential fluid leak paths through the pressure port body 110. For example, if the pressure port body 110 were formed of multiple components coupled to each other through adhesives or other means, the joints or adhesive may present a potential leak path. Contrarily, sealing members disposed about the protrusion 120 of the illustrated embodiment may effectively prevent fluid communication between a fluid adjacent the bottom opening 124 and other portions of the pressure port assembly 100 (except along the aperture 125). Thus, only the pressure port body 110, the seals, and the bottom surface of the pressure transducer 130 need to be configured for direct contact with the fluid to be measured. This can facilitate isolation and control of harsh or corrosive fluids only to desired portions of the pressure port assembly 100.

It is within the scope of this disclosure to form or utilize a pressure port body 110 comprising a continuous material, including integrally formed pressure port bodies and other monolithic pressure port bodies.

Still further, in some embodiments, multiple seals may be used to prevent fluid flow around the periphery of the pressure port body 110. For example, one or more O-rings may be disposed about the protrusion 120, and one or more seals may be disposed against the bottom surface 114 of the pressure port body 110. Any joints or openings within the pressure port body 110, including openings between such seals, would reduce the efficacy of the seals, by presenting potential leak paths. Thus, multiple seals may be used in connection with a pressure port body 110 comprising a continuous material in order to isolate or control fluid communication.

The pressure port assembly 100 may thus be used to facilitate disposition of a pressure transducer 130 and/or an electronics assembly 140 on the opposite side of a port member, with respect to the fluid to be measured. An aperture 125 and seals may limit fluid communication only to desired portions of the pressure port assembly 100. This relative arrangement of components may facilitate fluidic sealing, the fluidic isolation of portions of the pressure port assembly 100.

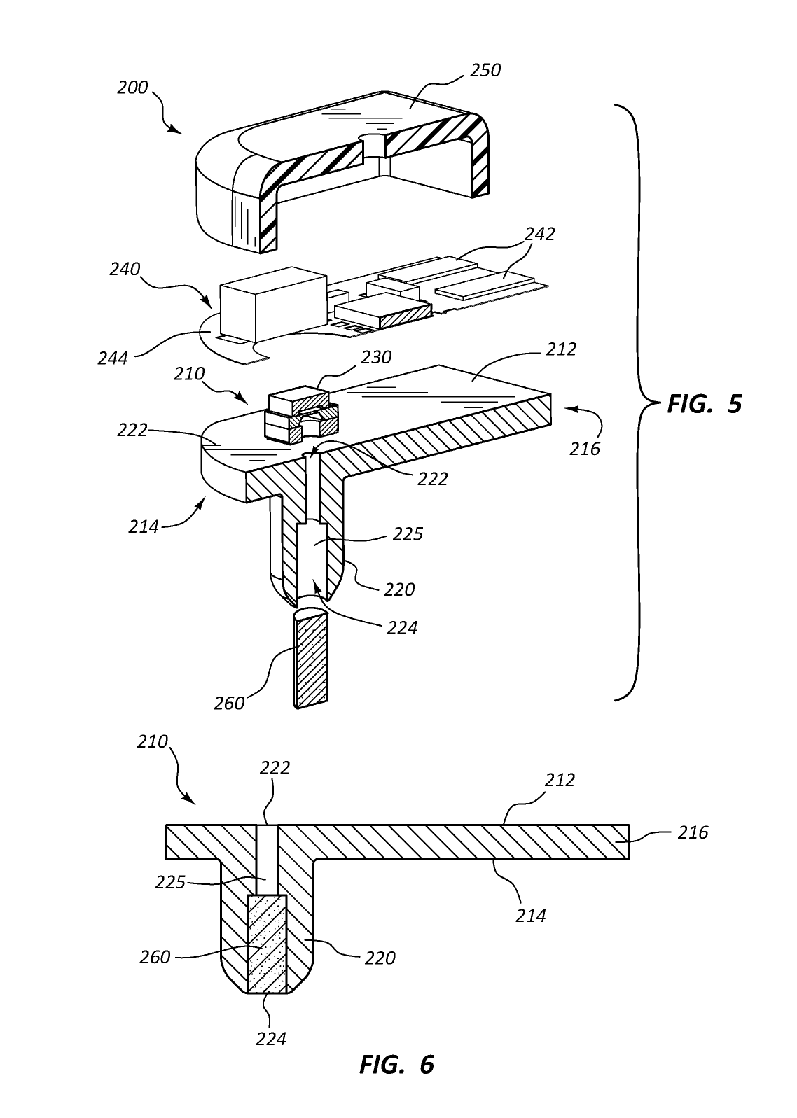

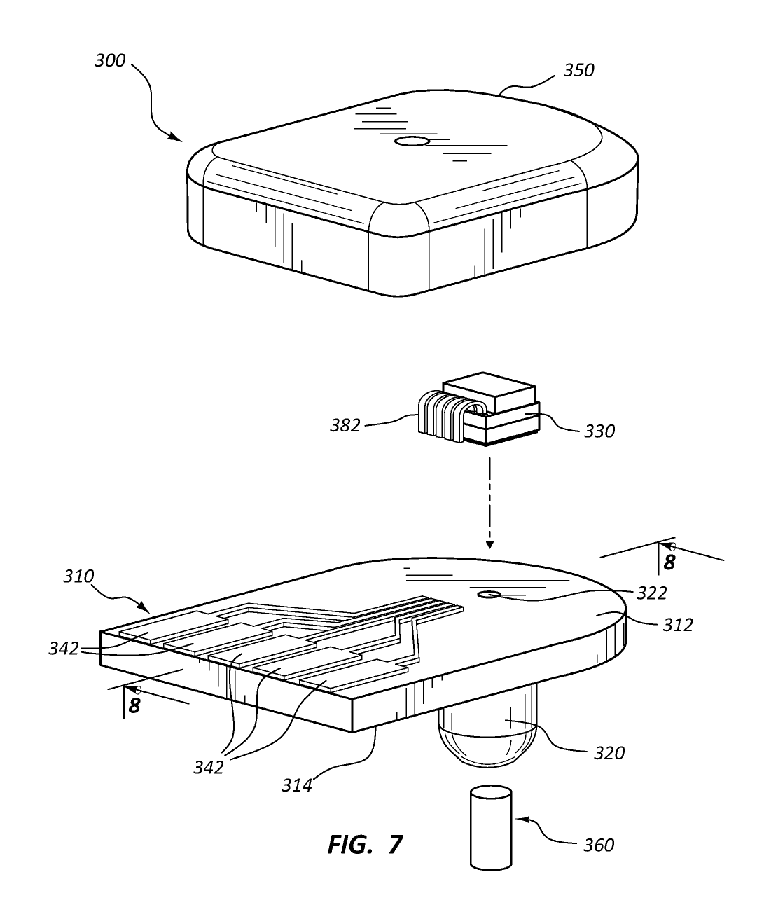

FIGS. 5-6 depict an embodiment of a sensor assembly 200 (or components thereof) that resembles the pressure port assembly 100 described above in certain respects. Accordingly, like features are designated with like reference numerals, with the leading digits incremented to “2.” For example, the embodiment depicted in FIG. 5 includes an electronics assembly 240 that may, in some respects, resemble the electronics assembly 140 of FIGS. 1-4. Relevant disclosure set forth above regarding similarly identified features thus may not be repeated hereafter. Moreover, specific features of sensor assemblies and related components shown in FIGS. 1-4 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the sensor assembly 200 and related components depicted in FIGS. 5-6. Any suitable combination of the features, and variations of the same, described with respect to the sensor assembly 100 and related components illustrated in FIGS. 1-4 can be employed with the sensor assembly 200 and related components of FIGS. 5-6, and vice versa. This pattern of disclosure applies equally to further embodiments depicted in subsequent figures and described hereafter, wherein the leading digits may be further incremented.

FIG. 5 provides an cross-sectional exploded perspective view of a sensor assembly 200. FIG. 6 provides a cross-sectional side view of a sensor mounting body 110 of the sensor assembly 200.

As shown in FIG. 5, the sensor assembly 200 may include a sensor mounting body 210, a protrusion 220, a pressure transducer 230, an electronics assembly 240, and a cover 250. These components, along with related components, may generally be arranged and configured as described above in connection with analogous components shown in FIGS. 1-4. For example, a pressure sensor (e.g., pressure transducer 230) may be coupled to a first side (e.g., a “top side” or “transducer side”) of the sensor mounting body 210.

In the embodiment depicted in FIGS. 5-6, the sensor mounting body 210 includes a flat portion 216. The flat portion 216 defines a first surface 212 (e.g., a “top surface” or a “transducer surface”) and a second (e.g., bottom) surface 214. The first surface 212 may be configured for interaction with a pressure sensor (e.g., pressure transducer 230) such that the pressure sensor is coupled to the first surface 212. The sensor mounting body 210 may also include a protrusion 220 that extends from the second surface 214. In some embodiments, the protrusion 220 is integrally formed with the flat portion 216.

In the depicted embodiment, the sensor mounting body 210 includes an aperture 225 that extends through both the protrusion 220 and the flat portion 216 of the sensor mounting body 210. Stated differently, the aperture may extend through the sensor mounting body 210. The aperture 225 may form a first opening 222 on a first (e.g., upper) side of the sensor mounting body 210 and a second opening 224 on a second (e.g., lower) side of the sensor mounting body 210. For example, the first opening 222 may be positioned on a first (e.g., upper) surface 212 of the sensor mounting body 210, while the second opening 224 may be positioned opposite the first opening 222 (e.g., adjacent a tip region of the protrusion 220).

In some embodiments, the sensor mounting body 210 is a continuous and unbroken piece of material. Stated differently, the sensor mounting body 210 may be integrally formed from a substantially uniform material. For example, in some embodiments, the flat portion 216 is integrally formed with the protrusion 220 by injection molding. In some embodiments, the sensor mounting body 210 and/or the continuous material comprises or consists essentially of a ceramic material. The sensor mounting body 210 and/or the continuous material may be impermeable to fluid flow across the continuous material. In other words, in some embodiments, liquid and/or gas in unable to pass through the material used to form the sensor mounting body 210.

In the depicted embodiment, the sensor assembly 200 includes a porous member 260. The porous member 260 may be disposed within the aperture 225 such that the first opening 222 is in fluid communication with the second opening 224 through fluid communication across the porous member 260. The porous member 260 may be coupled to the sensor mounting body 210 inside the aperture 225. In some embodiments, the porous member 260 may be coupled to the sensor mounting body 210 by an interference fit. For example, in some embodiments, the porous member may be inserted into the aperture 225 of the sensor mounting body 210 prior to firing or otherwise curing the ceramic material of the sensor mounting body 210. The sensor mounting body 210 may then be heated, causing the sensor mounting 210 to contract. Firing a sensor mounting body 210 that is made from continuous ceramic material may shrink the ceramic material thereby causing the continuous ceramic material to shrink around and engage the porous member 260. Stated differently, contraction of the sensor mounting body 210 may shrink the aperture 225, thereby coupling the porous member 260 to the sensor mounting body 210. Such contraction may result in an interference fit between the sensor mounting body 210 and the porous member 260.

In other or further embodiments, the porous member 260 is secured within the aperture 225 via bonding, welding, adhesives, chemical bonding, mechanical bonding, soldering and so forth. In some instances, eutectic solder is used to bond the porous member 260 to the pressure port body 210. In another example, glass bonding, such as glass soldering or frit bonding, is used to couple the porous member 260 to the the pressure port body 110.

The porous member 260 may be formed from any suitable material. For example, in some embodiments, the porous member 260 comprises or consists essentially of a ceramic material. In other or further embodiments, the porous member 260 comprises or consists essentially of a polymeric material. In some embodiments, the porous member 260 comprises or consists essentially of a sintered metal. In some embodiments, the porous member 260 comprises or consists essentially of glass, polytetrafluoroethylene, expanded PTFE, or porous silicon.

The durability of the sensor assembly 200 may relate to its ability to withstand rapid changes in pressure. By way of illustration, a sensor assembly 200 may be used to measure the pressure of a fluid by connecting the sensor assembly 200 to a device or component that such fluid within a fluid flow path is in fluid communication with a pressure sensor (e.g., pressure transducer 230) through the aperture 225. In some circumstances, the pressure of fluid within the flow path may rapidly change between pressures of significantly different magnitude. Such rapid changes in pressure may damage a pressure sensor (e.g., pressure transducer 230) by, for example, tearing or rupturing a diaphragm of the pressure sensor. More specifically, as the pressure within the compartment is rapidly changes, a pressure wave of significant magnitude may be propagated, causing a nearly discontinuous change in pressure that may damage a sensor assembly component.

The porous member 260 may function as a dampening element or snubber that disrupts the propagation of a pressure wave that could potentially damage the pressure transducer 230 or some other element of a sensor assembly 200. Stated differently, the porous member 260 may diffuse one or more pressure hammers, thereby protecting one or more elements of a sensor assembly 200 from pressure spikes (i.e., sharp increases or decreases in pressure) that could damage the element.

The porous member 260 may additionally or alternatively function as a filter to catch particulates that may be disposed within the aperture 225. For example, the porous member may protect the pressure transducer 230 from particulates that might otherwise collide with and/or damage the diaphragm of the pressure transducer 230. In this manner, the porous member 260 may protect the sensor assembly 200 from abrasive particulates.

In other embodiments, a sensor assembly may differ somewhat in shape and/or size from the sensor assembly 200. For example, a first surface of a sensor assembly may be sized to couple to a pressure transducer, but lack additional space for coupling of an electronics assembly to the first surface. In other or further embodiments, the first surface of the sensor mounting body may be generally rounded or circular in shape. Other suitable shapes and configurations for the sensor assembly in which a dampening element (e.g., a snubber) is disposed between the pressure transducer and fluid within a fluid reservoir are within the scope of this disclosure. The shape and size of the sensor mounting assembly may also be modified to securely couple to fluid reservoirs of various shapes and sizes.

Various methods of using the systems and devices described above are within the scope of this disclosure. For example, methods of providing fluid communication across a pressure port body or a sensor port body and methods of measuring pressures at a location offset from a pressure transducer are within the scope of this disclosure.

Furthermore, methods of forming a pressure port assembly or a sensor assembly are within the scope of this disclosure. Some such methods include methods of forming a pressure port body or a sensor mounting body through injection-molding, including injection-molding of a ceramic material. Still further, methods of directly metallizing a pressure port body or a sensor mounting body to provide electrical pathways are contemplated by this disclosure.

Some methods of forming a pressure port assembly or a sensor assembly, such as sensor assembly 200, may include the steps of (1) integrally forming a sensor mounting body 210 and (2) coupling a porous member 260 within a portion of an aperture 225 of the sensor mounting body 210. As noted above, in some embodiments, the sensor mounting body 210 includes a flat portion 216 defining a first surface 212 and a second surface 214, a protrusion 220 extending from the second surface 214 of the flat portion, and an aperture extending through both the protrusion 220 and the flat portion 216 to the first side 212 of the flat portion 216.

In some embodiments, a method for forming a sensor assembly 200 may further include coupling a sensor (e.g., pressure transducer 230) to the first surface 112 of the flat portion 216 such that a portion of the sensor is in fluid communication with the aperture 225.

In some embodiments, a method for forming a sensor assembly 200 may additionally or alternative include coupling one or more electronic components (e.g., the electronics assembly 240) to the first surface 212. For example, in some embodiments, one or more electronics components may be coupled to a membrane which is coupled to the first surface 212. In some embodiments, circuitry may be directly deposited or printed onto a first surface 212 of the sensor mounting body 210.

In some embodiments, integrally forming the sensor mounting body 210 includes forming the sensor mounting body 210 from a continuous ceramic material. In other or further embodiments, coupling the porous member 260 within a portion of the aperture 225 includes firing the continuous ceramic material of the sensor mounting body 210 when the porous member 260 is disposed within the aperture 225 such that the continuous ceramic material shrinks around and engages the porous member 260.

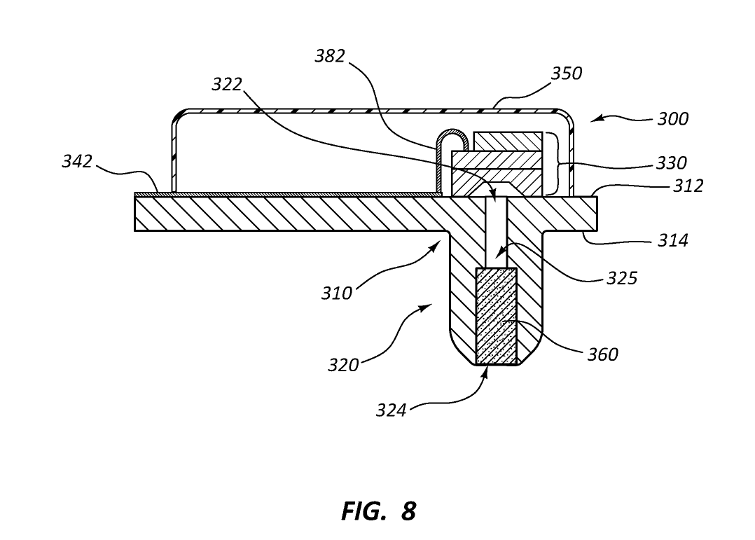

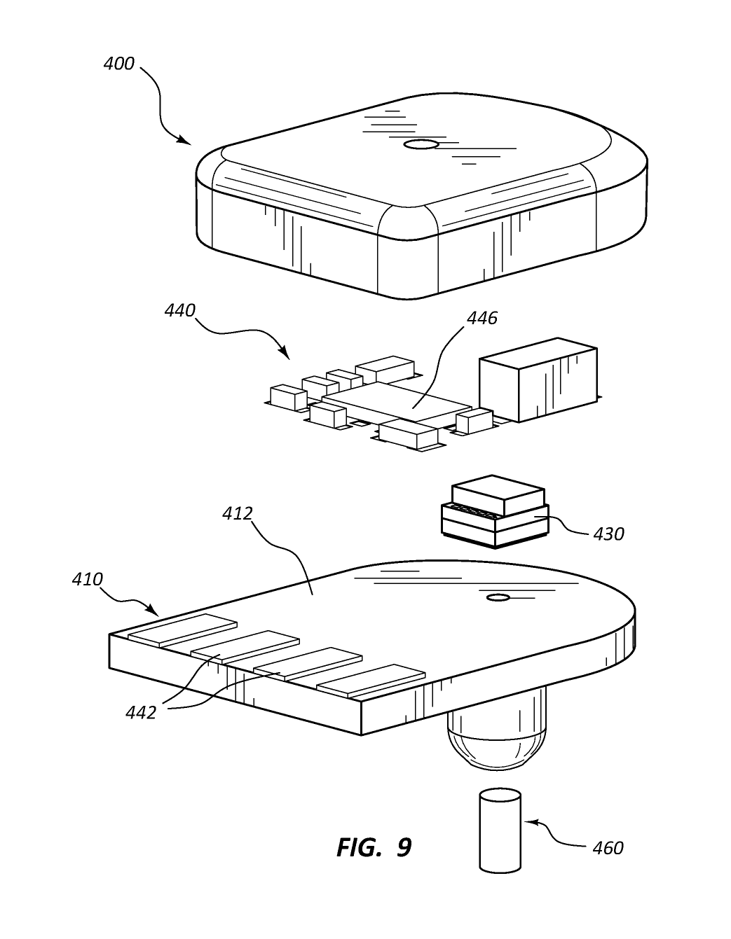

FIGS. 7 and 8 depict a pressure port assembly 300 according to another embodiment. As shown in FIGS. 7 and 8, the pressure port assembly 300 includes a pressure port body 310 (alternatively referred to as a sensor mounting body), a pressure sensing element (e.g., pressure transducer 330), and a cover 350, and a porous member 360, but does not include a chip carrier or board analogous to the chip carriers 144, 244 of FIGS. 1-6. The pressure port assembly 300 also lacks some of the electrical components shown in FIGS. 1-6.

The pressure port body 310 may be a monolithic piece. For example, in some embodiments, the pressure port body 310 is formed from a single piece of ceramic. In some embodiments, the pressure port body 310 includes a fluid-impermeable material. The fluid-impermeable material (e.g., ceramic) may be configured for contact with harsh or corrosive fluids. The impermeability of the pressure port body 310 may isolate and protect others portions of the pressure port assembly 300 from the fluid. In some embodiments, the pressure port body 310 may also be configured to withstand significant changes in pressure. The impermeability of the pressure port body 310 may isolate and protect other portions of the pressure port assembly 300 from significant changes in fluid pressure. In some embodiments, the pressure port body 310 includes a top surface 312 and a bottom surface 314.

In the depicted embodiment, electrical contacts 342 are deposited on or otherwise attached directly to a top surface 312 of the pressure port body 310. In some embodiments, the electrical contacts 342 may be deposited on the pressure port body 310 by metallization. Such metallization may be accomplished by various methods. For example, in some embodiments, at least a portion of the top surface 312 of the pressure port body 310 is metallized by plating, such as sputter deposition or vapor deposition under vacuum. In some embodiments, the pressure port body 310 is metallized via gold plating. In some embodiments, metallization is accomplished via electroplating. Such electroplating may be carried out by depositing metal on the top surface 312 of the pressure port body 310 by the use of electrons to form a non-ionic layer or coating on the top surface 312. In some embodiments, metallization is accomplished via electroless plating, also known as chemical or autocatalytic plating. The deposition of metal onto a top surface 312 of a pressure port body 310 via electroless plating may involve reactions that deposit metal onto the surface 312 without the use of external electrical power. For example, metal may be deposited on the top surface 312 of the pressure port body 310 via one or more redox reactions. In some embodiments, metallization is accomplished via screen printing. In some screen printing processes, an “ink” may be prepared by mixing metal or ceramic powders with one or more organic compounds to form a paste. This paste (i.e., the “ink”) may be transferred to a substrate (e.g., a top surface 312 of the pressure port body 310) through a patterned woven mesh screen or stencil. Such paste may be applied, for example, using a squeegee. The deposited “ink” may then be dried and heated to a relatively high temperature (e.g., greater than 300° C.). Other methods of metallization may also be used.

Metals that are suitable for metallization may include copper, gold, silver, tin, platinum, palladium, nickel, tungsten, kovar, germanium, aluminum, molybdenum, titanium, chrome, and vanadium, among other metals. Combinations of such metals may also be used. The electrical contacts 342 that are deposited by metallization may be viewed as a metallized layer or coating that is disposed on a portion of the top surface 312 of the pressure port body 310. In some embodiments, the metallized layer or coating is uniformly applied over an entirety of the top surface 312 of the pressure port body 310, and then portions of the layer or coating are removed to create the electrical contacts 342 and/or other electrical pathways.

The electrical contacts 342 may be in electrical communication with a pressure transducer 330. For example, in the depicted embodiment, the electrical contacts 342 are in electrical communication with the pressure transducer 330 via wire bonds 382 that extend from the electrical contacts 342 to the pressure transducer 330. In other embodiments, the electrical contacts 342 may be in direct electrical communication with the pressure transducer 330 or in electrical communication with the pressure transducer 330 in some other way. The electrical contacts 342 may be configured to receive a signal from the transducer 330 (e.g., a signal that is representative of the pressure within a fluid line) and then output and/or relay the signal to other electric components. In other words, the contacts 342 may also be in electrical communication with one or more other components and devices (e.g., an output screen).

In some embodiments, the pressure port body 310 includes a protrusion 320. The protrusion 320 may extend from a bottom surface 314 of the pressure port body 310 and away from the top surface 312 of the pressure port body 310. An aperture 325 may extend across the pressure port body 310 from a top opening 322 to a bottom or distal opening 324 in the protrusion 320. The aperture 325 may provide a defined path for fluid communication across the pressure port body 310.

The porous member 360 may be disposed within the aperture 325 such that the top opening 322 is in fluid communication with the bottom opening 324 through fluid communication across the porous member 360. The porous member 360 may be coupled to the pressure port body 310 via an interference fit and function as a dampening element or snubber that disrupts the propagation of a pressure wave that could potentially damage the pressure transducer 330 or some other element of the pressure port assembly 300.

The pressure transducer 330 may be in fluid communication with the aperture 325. For example, the pressure transducer 330 may be coupled to the top surface 312 of the pressure port body 310 such that the pressure transducer 330 is in fluid communication with the aperture 325. More specifically, in some embodiments, the pressure transducer 330 may be bonded to the top surface 312 of the pressure port body 310, thereby sealing the top opening 322 of the apertures 325. Attachment of the pressure transducer 330 to the top surface 312 in this manner may allow for fluid communication between the aperture 325 and the bottom of the pressure transducer 330, but prevent fluid communication between the aperture 325 and one or more other components of the pressure port assembly 300.

The pressure transducer 330 may be used to sense the pressure of a fluid in the aperture 325 and generate a signal representative of the pressure. For example, when protrusion 320 is disposed within a fluid line such that the aperture 325 is in fluid communication with fluid in the fluid line, the pressure transducer 330 may be used to determine the pressure of fluid within the fluid line. As noted above, a signal representative of the pressure may travel from the transducer 330 to the electrical contacts 342, which enable output of the signal.

The pressure assembly port assembly 300 may also include other components, such as components analogous to those discussed above in connection with FIGS. 1-6. For example, the pressure port assembly may include a cover 350 that is analogous to the covers 150, 250 discussed above. The pressure port assembly 300 may also be a portion of a larger assembly or device.

FIG. 9 provides an exploded view of a pressure port assembly 400 according to another embodiment. The pressure port assembly 400 is analogous to the pressure port assembly 300, except that the pressure port assembly 400 includes various electrical components 440 that are not included in the pressure port assembly 300.

For example, the pressure port assembly 400 includes an integrated circuit 446. When the pressure port assembly 400 is fully assembled, the integrated circuit 446 may be mounted or otherwise coupled to the first flat surface 412 of the pressure mounting body 410. In the depicted embodiment, the integrated circuit 446 is configured to attach to the first flat surface 412 without any intervening chip carrier. In some embodiments, the integrated circuit 446 is an application-specific integrated circuit. Other electronic components, such as resistors, transistors, etc. may also be attached directly to the first flat surface 412. In some embodiments, a signal may travel from the pressure transducer 430 through one or more electrical components 440 (e.g., the integrated circuit 446) to the electrical contacts 442 for output of the signal.

In some embodiments, the pressure port assembly 400 may include a porous member 460 analogous to the porous members 260, 360 discussed above. In other embodiments, the pressure port assembly lacks a porous member analogous to the porous member 260, 360 discussed above.

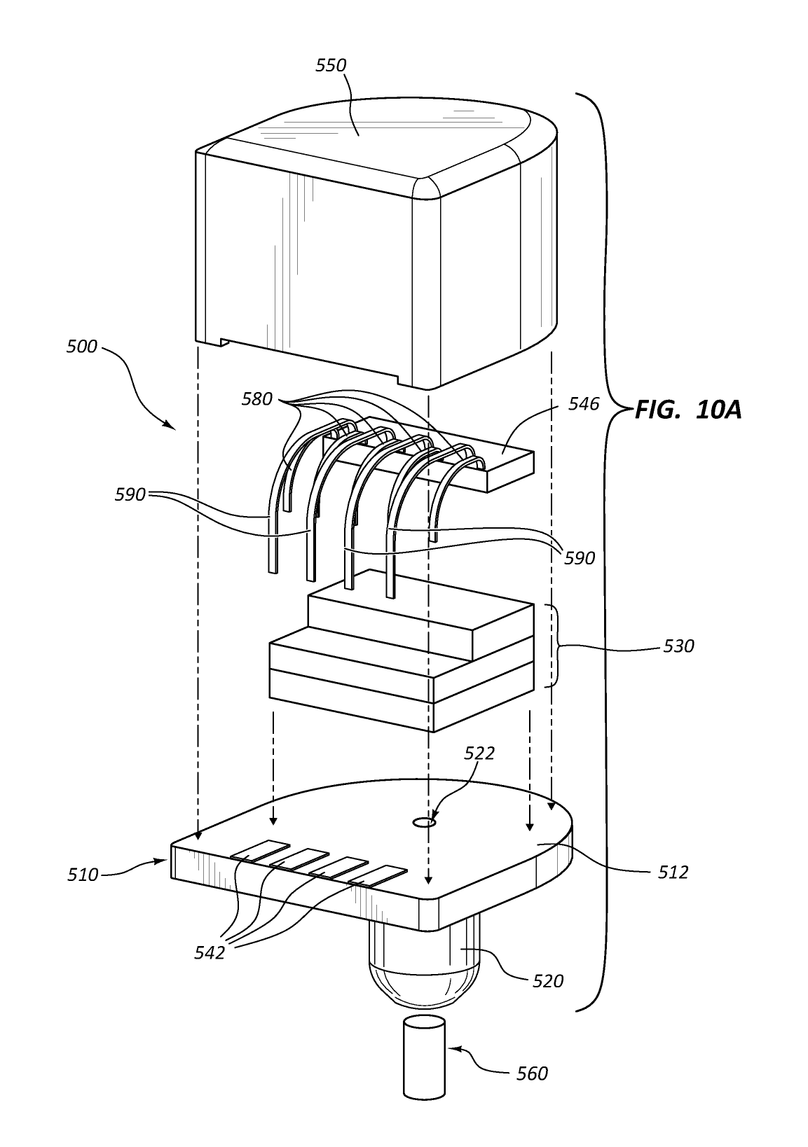

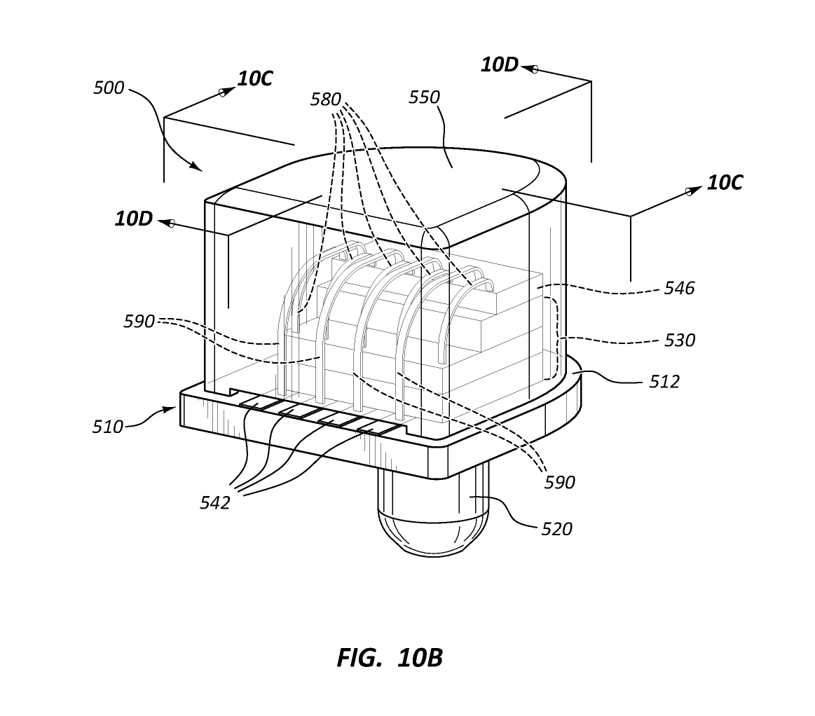

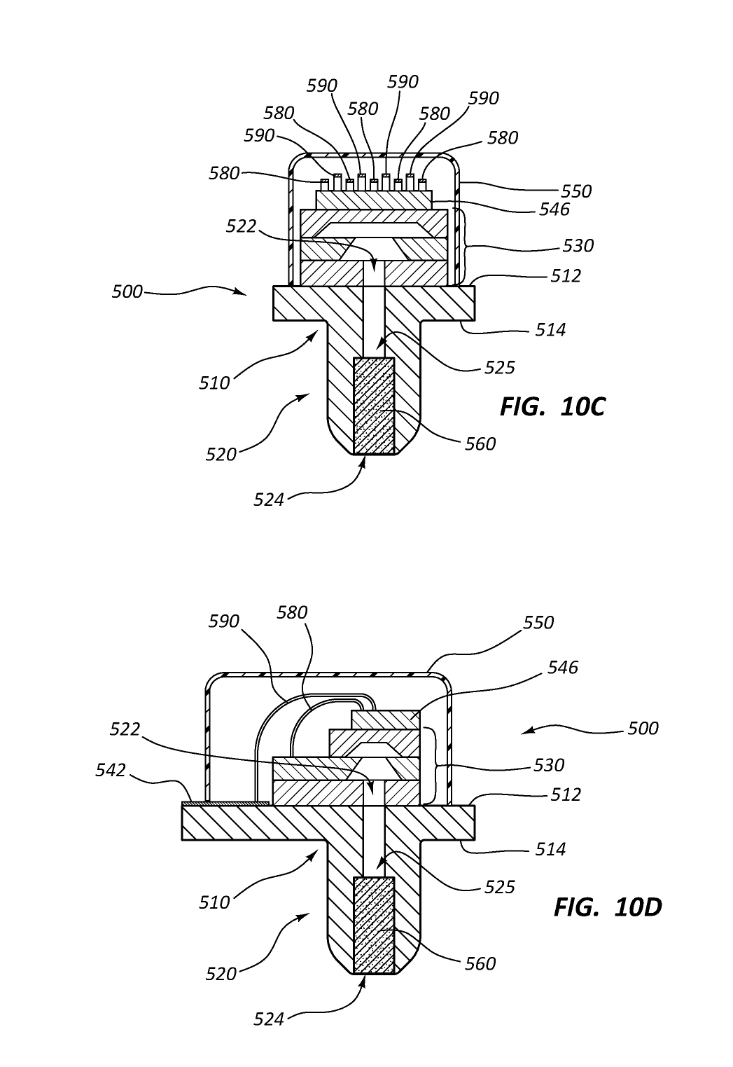

FIGS. 10A-10D provide alternative views of a pressure port assembly 500 according to another embodiment. More particularly, FIG. 10A is an exploded view of the pressure port assembly 500. FIG. 10B is a non-exploded view of the pressure port assembly 500. FIGS. 10C and 10D are different cross-sectional views of the pressure port assembly.

With reference to FIGS. 10A-10D, the pressure port assembly 500 may include a pressure port body 510 (alternatively referred to as a sensor mounting body), a pressure sensing element (e.g., pressure transducer 530), an integrated circuit 546 and a cover 550.

Similar to some of the embodiments described above, the pressure port body 510 may be a monolithic piece. For example, in some embodiments, the pressure port body 510 is formed from a single piece of ceramic. In some embodiments, the pressure port body 510 includes a fluid-impermeable material. The fluid-impermeable material (e.g., ceramic) may be configured to withstand harsh or corrosive fluids. The impermeability of the pressure port body 510 may isolate and protect others portions of the pressure port assembly 500 from the fluid. In some embodiments, the pressure port body 510 may also be configured to withstand significant changes in pressure. The impermeability of the pressure port body 510 may isolate and protect other portions of the pressure port assembly 500 from significant changes in fluid pressure. In some embodiments, the pressure port body 510 includes a top surface 512 and a bottom surface 514.

Electrical contacts 542 may be deposited on or otherwise attached directly to a top surface 512 the pressure port body 510. In some embodiments, the electrical contacts 542 may be deposited on the pressure port body 510 by metallization. Such metallization may be accomplished by, for example, plating, electroplating, electroless plating, or screen printing, although other methods of metallization may also be used. Metals that are suitable for metallization may include copper, gold, silver, tin, platinum, palladium, nickel, tungsten, kovar, germanium, aluminum, molybdenum, titanium, chrome, and vanadium, among other metals. The electrical contacts 542 that are deposited by metallization may be understood as a metallized layer or coating that is disposed on a portion of the top surface 512 of the pressure port body 510.

In some embodiments, the pressure port body 510 includes a protrusion 520. The protrusion 520 may extend from a bottom surface 514 of the pressure port body 510 and away from the top surface 512 of the pressure port body 510. An aperture 525 may extend across the pressure port body 510 from a top opening 522 to a bottom or distal opening 524 in the protrusion 520. The aperture 525 may provide a defined path for fluid communication across the pressure port body 510. In some embodiments, the aperture 525 is the only aperture that extends across the pressure port body 510.

The porous member 560 may be disposed within the aperture 525 such that the top opening 522 is in fluid communication with the bottom opening 524 through fluid communication across the porous member 560. The porous member 560 may be coupled to the pressure port body 510 via an interference fit and function as a dampening element or snubber that disrupts the propagation of a pressure wave that could potentially damage the pressure transducer 530 or some other element of the pressure port assembly 500.

The pressure transducer 530 may be in fluid communication with the aperture 525. For example, the pressure transducer 530 may be coupled to the top surface 512 of the pressure port body 510 such that the pressure transducer 530 is in fluid communication with the aperture. More specifically, in some embodiments, the pressure transducer 530 may be bonded to the top surface 512, thereby sealing the top opening 522 of the aperture 525. Attachment of the pressure transducer 530 to the top surface 512 in this manner may allow for fluid communication between the aperture 525 and the bottom of the pressure transducer 530, but prevent fluid communication between the aperture 525 and one or more other components of the pressure port assembly 500, such as the integrated circuit 546 described below.

An integrated circuit 546 may be coupled to the pressure transducer 530 such that the pressure transducer 530 is disposed between the top surface 512 and the integrated circuit 546. For example, the integrated circuit 546 may be stacked on top of the pressure transducer 530 and coupled to the pressure transducer 530 via an adhesive. This arrangement of components may be more compact than other arrangements in which the integrated circuit 546 and the pressure transducer 530 are not in a stacked configuration.

The pressure transducer 530, the integrated circuit 546, and the electrical contacts 542 may be in electrical communication with one another. For example, the pressure transducer 530 may be electrically connected to the integrated circuit 546 by a first plurality of electrical leads 580. The integrated circuit 530 may, in turn, be electrically connected to the electrical contacts 542 via a second plurality of leads 590. Thus, the pressure transducer 530 may be in electrical communication with the electrical contacts 542 through an integrated circuit 546 and the accompanying leads 580, 590. In FIGS. 10A-10D, the electrical leads 580, 590 are depicted as wires (e.g., gold wires), although other types of electrical leads are also within the scope of this disclosure.

In operation, the pressure transducer 530 may send a signal that is representative of the pressure to the integrated circuit 546. The integrated circuit 546 may perform one or more operations on the signal and then send or relay the signal to the electrical contacts 542. The electrical contacts 542 may be configured for electrical communication with one or more other components and devices. Thus, the electrical contacts 542 may be configured to receive a signal from the pressure transducer 530 (e.g., a signal that is representative of the pressure within a fluid line) and then output and/or relay the signal to other electrical components. In this manner, the pressure port assembly 500 may be used to determine the pressure of fluid within a fluid line.

Various methods of using the systems and devices described above are within the scope of this disclosure. For example, methods of providing fluid communication across a pressure port body, methods of disrupting a propagating pressure wave, and methods of measuring pressures at a location offset from a pressure transducer are within the scope of this disclosure.

Furthermore, methods of forming a pressure port assembly are within the scope of this disclosure. Some such methods include methods of forming a pressure port body through injection-molding, including injection-molding of a ceramic material. Such methods may also include contracting of a pressure port body around a porous member. Still further, methods of directly metallizing a pressure port body to provide electrical pathways are contemplated by this disclosure.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

1. A sensor assembly comprising:
a monolithic sensor mounting body comprising:
a first flat surface;
a second flat surface disposed opposite the first flat surface;
a protrusion extending from the second flat surface and away from the first flat surface; and
an aperture that extends across the sensor mounting body from an opening in the first flat surface to an opening in the protrusion;
a porous member disposed within the aperture such that the first opening is in fluid communication with the second opening through fluid communication across the porous member;
a metallized layer disposed on at least a portion of the first flat surface of the sensor mounting body; and
a pressure sensor that is coupled to the first flat surface such that the pressure sensor is in fluid communication with the aperture.

2. The sensor assembly of claim 1, wherein the monolithic sensor mounting body is formed from a fluid-impermeable ceramic material.

3. The sensor assembly of claim 1, wherein the metallized layer is configured for electrical communication with the pressure sensor.

4. The sensor assembly of claim 1, further comprising an integrated circuit that is mounted to the first flat surface of the sensor mounting body.

5. The sensor assembly of claim 4, wherein the pressure transducer is disposed between the first flat surface and the integrated circuit.

6. The sensor assembly of claim 5, wherein the pressure transducer is electrically coupled to the integrated circuit via a first plurality of leads and the integrated circuit is electrically coupled to electrical contacts on the sensor mounting body via a second plurality of leads.

7. The sensor assembly of claim 1, wherein the porous member comprises a ceramic material.

8. The sensor assembly of claim 1, wherein the porous member comprises a polymeric material.

9. The sensor assembly of claim 1, wherein the porous member comprises sintered metal.

10. The sensor assembly of claim 1, wherein the porous material couples to the sensor mounting body by an interference fit.

11-29. (canceled)

30. A method of forming a sensor assembly, the method comprising:
integrally forming a sensor mounting body, the sensor mounting body comprising:
a flat portion defining a first side and a second side;
a protrusion extending from the second side of the flat portion, the protrusion integrally formed with the flat portion; and
an aperture extending from a surface of the protrusion to the first side of the flat portion; and
securing a porous member within the aperture of the sensor mounting body.

31. The method of claim 30, further comprising coupling a sensor to the first side of the flat portion, such that a portion of the sensor is in fluid communication with the aperture.

32-34. (canceled)

35. The method of claim 30, wherein integrally forming the sensor mounting body comprises forming the sensor mounting body from a continuous ceramic material.

36. The method of claim 30, wherein integrally forming the sensor mounting body comprises injection-molding the sensor mounting body.

37. (canceled)

38. The method of claim 30, further comprising applying a metallized layer to at least a portion of the first side of the flat portion.

39. The method of claim 30, further comprising heating the sensor mounting body, thereby causing the sensor mounting body to contract around the porous member.

40-41. (canceled)

42. The method of claim 30, wherein securing a porous member within the aperture of the sensor mounting body comprises securing the porous member within the aperture of the sensor mounting body via an interference fit.

43. A sensor assembly comprising:
a sensor mounting body;
an aperture extending through the sensor mounting body to form a first opening on a first side of the sensor mounting body and a second opening on a second side of the sensor mounting body that is opposite of the first side of the sensor mounting body; and
a porous member disposed within the aperture such that the first opening is in fluid communication with the second opening through fluid communication across the porous member.

44. The sensor assembly of claim 43, wherein:
the sensor mounting body comprises a protrusion; and
the aperture extends through a portion of the protrusion.

45-48. (canceled)

49. The sensor assembly of claim 43, wherein the porous member comprises a ceramic material.

50. The sensor assembly of claim 43, wherein the porous member comprises a polymeric material.

51. The sensor assembly of claim 43, wherein the porous member couples to the sensor mounting body by an interference fit.

52. The sensor assembly of claim 43, further comprising a pressure sensor coupled to the first side of the sensor mounting body.

53. The sensor assembly of claim 43, further comprising a metallized layer disposed on at least a portion of the sensor mounting body.

54-69. (canceled)
